(19) United States
(12) Patent Application Publication
(10) Pub. No.: US 2021/0355729 A1
(43) Pub. Date: Nov. 18, 2021

(54) ACTUATOR FOR MOVING A FURNITURE FLAP

(71) Applicant: Julius Blum GmbH, Hoechst (AT)

(72) Inventor: Wolfgang BOHLE, Goetzis (AT)

(21) Appl. No.: 17/388,289

(22) Filed: Jul. 29, 2021

Related U.S. Application Data
(63) Continuation of application No. PCT/AT2020/060007, filed on Jan. 16, 2020.

(30) Foreign Application Priority Data
Jan. 31, 2019 (AT) A 50082/2019

(51) Int. Cl. E05F 3/00

(52) U.S. Cl. CPC E05F 3/00; E05Y 2900/20; E05Y 2201/604

(57) ABSTRACT

An actuating drive includes an actuating arm pivotally supported about a pivoting axis, and movably supported between a closed position and an open position. A force storage member applies a force to the actuating arm, and a coupling device can brake or prevent a pivotal movement of the actuating arm. The coupling device includes a movably-supported first coupling element having a tooth arrangement, and the first coupling element can engage a second coupling element when a predetermined pivotal speed of the actuating arm is exceeded to brake or prevent the pivotal movement of the actuating arm. The second coupling element includes an engagement section for engaging the two coupling elements together, and includes a freewheel section separate from the engagement section. In the closed position, the first coupling element is within the freewheel section of the second coupling element, whereby the two coupling elements are decoupled from one another.

### BACKGROUND OF THE INVENTION

The present invention relates to an actuating drive for moving a furniture flap movably-supported relative to a furniture carcass, the actuating drive comprising:
at least one actuating arm pivotally supported about a pivoting axis for moving the furniture flap, the at least one actuating arm being movably supported between a closed position corresponding to a closed position of the furniture flap relative to the furniture carcass in a mounted condition of the furniture flap, and an open position,
a force storage member for applying a force to the at least one actuating arm, and
a coupling device for braking or preventing a pivotal movement of the at least one actuating arm. The coupling device includes at least one movably-supported first coupling element having a tooth arrangement, and the at least one first coupling element is configured to be engaged with a second coupling element when a predetermined pivotal speed of the actuating arm is exceeded. The pivotal movement of the at least one actuating arm is braked or prevented, and the second coupling element includes at least one engagement section for engaging the two coupling elements with one another.

Moreover, the invention relates to an item of furniture comprising a furniture carcass, a furniture flap movably-supported relative to the furniture carcass, and an actuating drive of the type to be described for moving the furniture flap.

Actuating drives for moving furniture flaps usually have at least one pivotally-supported actuating arm and a force storage member in the form of a spring device for applying a force to the actuating arm. By the force storage member, the weight of the furniture flap can be at least partially compensated for. As a result, the movement of the furniture flap can be facilitated for a person. The actuating arm, depending on the size and the weight of the furniture flap, is pressurized with extremely large pre-stressing forces of the force storage member in a direction of the open position. Critical situations can arise, in particular, when the furniture flap has not yet been connected to the actuating arm. In such a case, there is no counter-weight acting on the actuating arm, whereby the actuating arm can massively kick out by the force of the force storage member, and injuries of persons and damages to objects can be caused.

WO 2006/069412 A1 and WO 2010/051569 A1 disclose actuating drives for moving furniture flaps, the actuating drives being equipped with a centrifugal clutch for preventing an uncontrolled kicking-out movement of the actuating arm in a direction of the open position. The centrifugal clutch ensures that the actuating arm, below a predetermined pivotal speed, can be moved in a controlled manner. Above the predetermined pivotal speed, an automatic locking of the actuating arm can be provided by the centrifugal clutch. As a result, the actuating arm can be locked in its pivotal position and cannot further kick out in a direction of the open position.

In practice, problems with the centrifugal clutch can arise insofar when the actuating drive has already been pre-mounted to the item of furniture, and the actuating arm is connected to the furniture carcass on the one hand and to the furniture flap on the other hand. When the furniture flap is located in a closed position relative to the furniture carcass, it may occur that the coupling elements of the centrifugal clutch inadvertently get jammed with one another, for example by a transport of by a tilting movement of the furniture carcass upon its mounting operation. The actuating arm, due to the blocked centrifugal clutch, is arrested in its closed position and can no longer be moved in a direction of the closed position, because the furniture flap bears against the furniture carcass. Therefore, the jamming of the centrifugal clutch and the blockage of the actuating arm cannot be released. An opening movement of the furniture flap is then frequently only possible with resultant damage of the furniture flap or of the actuating drive.

### SUMMARY OF THE INVENTION

It is an object of the present invention to propose an actuating drive of the type mentioned in the introductory part, thereby avoiding the above-discussed drawbacks.

According to the invention, the second coupling element includes a least one freewheel section separate from the engagement section, wherein the first coupling element, in the closed position of the actuating arm, is arranged within the freewheel section of the second coupling element, whereby the two coupling elements are decoupled from one another in the closed position of the actuating arm.

In other words, the second coupling element includes at least one freewheel section configured to prevent an engagement, in particular a positive locking, of the two coupling elements to one another in the closed position of the actuating arm and/or in a pivoting range immediately preceding the closed position of the actuating arm.

In the closed position of the actuating arm, the first coupling element is configured to bear against the freewheel section of the second coupling element. The surface of the freewheel section can be configured substantially toothless or substantially smooth. The freewheel section can also have a different surface finish. However, it shall be ensured that a locking between the two coupling elements is not possible in the closed position of the actuating arm.

According to an embodiment, by the freewheel section of the second coupling element, the two coupling elements are decoupled from one another within a pivoting angle range of the actuating arm resulting between the closed position of the actuating arm and an opening position of the actuating arm of maximum 30°, preferably maximum 20°.

According to an embodiment of the invention, the second coupling element includes a substantially annular-shaped inner contour, and both of the engagement section and the freewheel section are arranged or formed on the annular-shaped inner contour of the second coupling element.

The engagement section of the second coupling element can include, for example, a counter-toothing configured to lock the first coupling element in a form-locking manner. On the contrary, the freewheel section can form a substantially smooth surface on which the first coupling element, in the closed position of the actuating arm, can bear against.

### BRIEF DESCRIPTION OF THE DRAWINGS

Further details and advantages of the present invention result from the following description of figures.

FIG. 1 is a side view of an item of furniture with a furniture carcass, a furniture flap located in an open position and with an actuating drive for moving the furniture flap,

FIG. 2 shows the item of furniture according to FIG. 1, in which the furniture flap achieves a closed position relative to the furniture carcass,

FIG. 3a-3c show the actuating drive in a side view and two enlarged detail views thereof, the actuating arm being in a closed position,

FIG. 4a-4c show the actuating drive in a side view and two enlarged detail views thereof, the actuating arm being in a locked open position,

FIG. 5a, 5b is a perspective view of a coupling portion of the actuating drive, the coupling portion being configured to be connected to the actuating arm, and an enlarged detail view thereof,

FIG. 6a, 6b shows the coupling device in an exploded view and an enlarged detail view thereof.

### DETAILED DESCRIPTION OF THE INVENTION

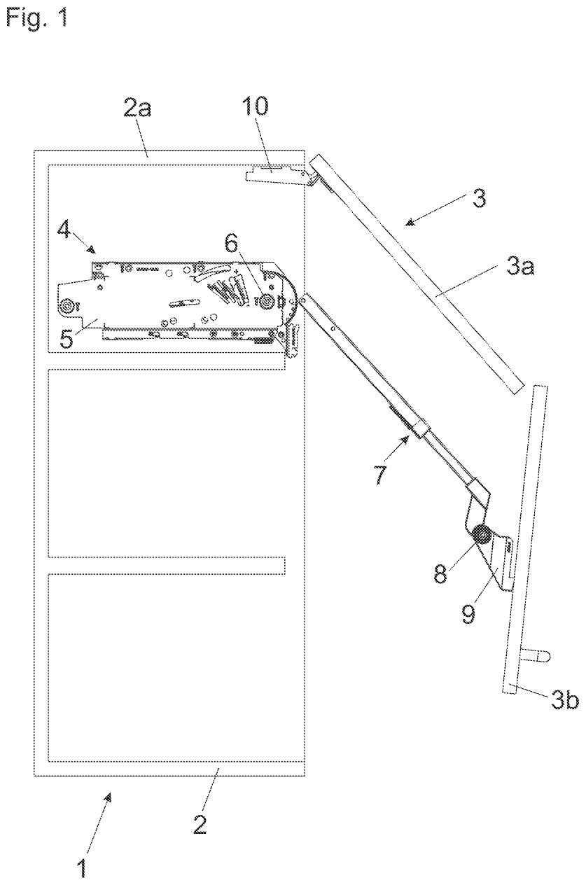

FIG. 1 shows an item of furniture 1 with a furniture carcass 2 in a side view, in which a furniture flap 3 is movably-supported relative to the furniture carcass 2 by an actuating drive 4. In the shown embodiment, the furniture flap 3 has a two-part configuration and includes a first partial flap 3a pivotally fixed to an underside of a cover panel 2a of the furniture carcass 2 via hinges 10. The second partial flap 3b is hingedly connected to the first partial flap 3a. The actuating drive 4 includes a housing 5 configured to be fixed to the furniture carcass 2, and at least one actuating arm 7 for moving the furniture flap 3, the at least one actuating arm 7 being pivotally supported on the housing 5. It can be preferably provided that actuating arm 7 is configured to be adjustable in length. The actuating arm 7 is pivotally connected to a fitting portion 9 via a hinge axis 8, and the fitting portion 9 is configured to be fixed to an inner side of the second partial flap 3b, preferably via a mounting plate.

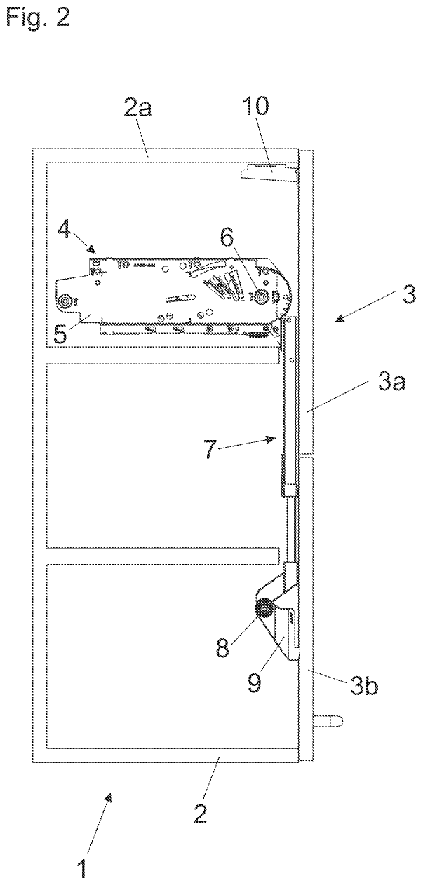

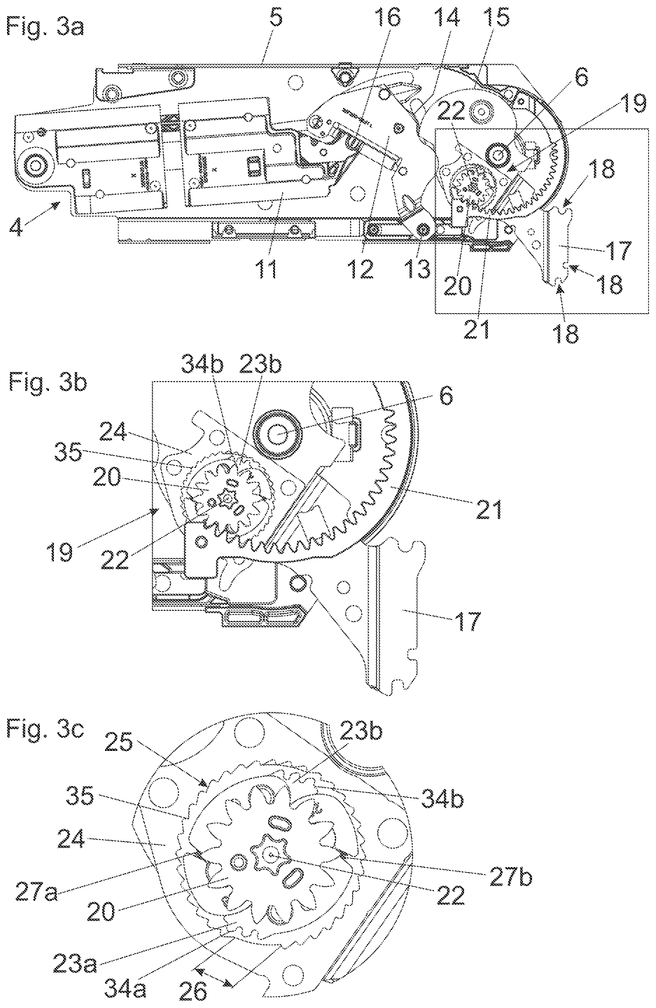

FIG. 2 shows a side view of the item of furniture 1 according to FIG. 1, and the furniture flap 3 is in a closed position in relation to the furniture carcass 2. The actuating drive 4 includes a force storage member 11 (FIG. 3a) for applying a force to the actuating arm 7, whereby the weight of the furniture flap 3 can be at least partially compensated for. Moreover, the actuating drive 4 includes a coupling device 19 (not shown here) for braking or preventing a pivotal movement of the at least one actuating arm 7. Therefore, an inadvertent opening or kicking-out movement of the vacant actuating arm 7, on which no furniture flap 3 has yet been fitted, caused by the force of the force storage member 11 acting in an opening direction, can be prevented. When the furniture flap 3 is in a fixed condition on the actuating arm 7, the coupling device 19 is not active. This is because the pivotal speed of the actuating arm 7, with a furniture flap 3 fixed to the actuating arm 7, is always far below a predetermined critical value. However, the coupling device 19 of the actuating drive 4, in the shown closed position of the furniture flap 3, can get jammed. As a result, the furniture flap 3 can neither be moved in the opening direction nor in the closing direction, and the jamming of the coupling device 19 cannot be released.

FIG. 3a shows a side view of the actuating drive 4 with the housing 5 configured to be fixed to the furniture carcass 2. The actuating arm 7 (not shown here) can be releasably connected to a coupling portion 17 pivotable about the pivoting axis 6. For fixing the actuating arm 7 in a form-locking manner, the coupling portion 17 has a plurality of recesses 18. For applying a force to the actuating arm 7, a force storage member 11 is provided. The force storage member 11 can include at least one helical spring, for example at least one compression spring or at least one tension spring. According to a preferred embodiment, the force storage member 11 includes a spring assembly having a plurality of compression springs arranged in a parallel relationship. The force storage member 11 is movably connected to an intermediate lever 12 via an engagement location 16, the intermediate lever 12 being pivotable about a pivoting axis 13. A pressure roller 14 is rotatably supported on the intermediate lever 12. A control contour 15 is formed on the coupling portion 17, and the pressure roller 14 of the intermediate lever 12 is configured to run along the control contour 15 of the coupling portion 17 upon a movement of the actuating arm 7 about the pivoting axis 6.

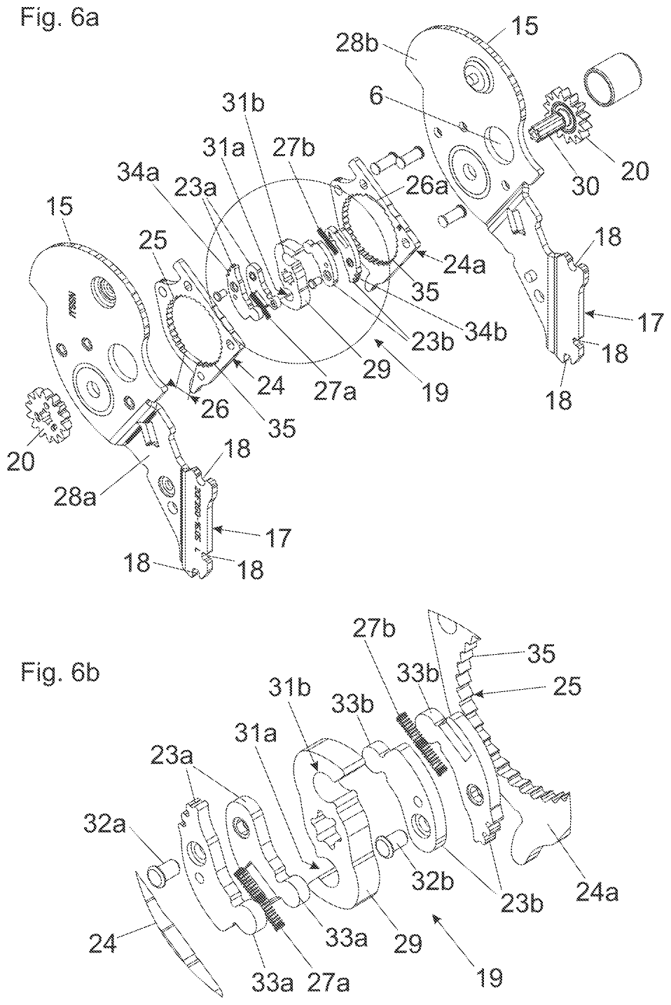

The actuating drive 4 includes a coupling device 19 for braking or preventing a pivotal movement of the at least one actuating arm 7, whereby an inadvertent kicking-out movement of the actuating arm 7, caused by a force of the force storage member 11 applied to the actuating arm 7 in a direction of the open position, can be prevented. For example, the coupling device 19 can include a centrifugal clutch. The coupling device 19 is configured to be driven by a gear 20 rotatable about a rotational axis 22, and the gear 20 is configured to run along a, preferably curved-shaped, toothed rack 21 upon a movement of the actuating arm 7 about the pivoting axis 6. The toothed rack 21 is formed or arranged on the housing 5 of the actuating drive 4. The gear 20 and the toothed rack 21 form a step-up gearing, by which a pivotal speed of the actuating arm 7, over a range of the pivoting path of the actuating arm 7, can be transmitted into a higher pivotal speed of a shaft 30 (FIG. 6a) supported on the rotational axis 22. With a transmission ratio of the step-up gearing of 1:4, this means that an angle change of the actuating arm 7 of 15° leads to a fourfold angle change of the shaft 30 supported on the rotational axis 22. Accordingly, the shaft 30 is thereby rotated about 60°. In this way, the reaction time of the coupling device 19 configured as a centrifugal clutch can be significantly reduced.

FIG. 3b shows the framed region of FIG. 3a in an enlarged view. Upon a movement of the actuating arm 7 (that is to say upon a movement of the coupling portion 17), the gear 20 can run along the toothed rack 21. The coupling device 19 includes at least one movably-supported first coupling element 23a, 23b (FIG. 3c) which, upon exceeding a predetermined pivotal speed of the actuating arm 7, is configured to be engaged with a second coupling element 24, whereby the pivotal movement of the actuating arm 7 can be braked or prevented.

FIG. 3c shows the coupling device 19 in an enlarged view. Two first coupling elements 23a, 23b are arranged on a common shaft 30 configured to be rotatable about the rotational axis 22. The two first coupling elements 23a, 23b are mutually spaced from one another in an axial direction of the shaft 30, and can be driven by the gear 20 running along the toothed rack 21. Each of the coupling elements 23a, 23b includes a tooth arrangement 34a, 34b configured to be locked with a counter-toothing 35 of an engagement section 25 arranged on the second coupling element 24 in a form locking manner, if the actuating arm 7 exceeds a predetermined pivotal speed. It can be seen that at least one freewheel section 26 is arranged on the second coupling element 24, the freewheel section 26 being configured to prevent a locking of the first coupling element 23a with the second coupling element 24 in the shown closed position of the actuating arm 7. In the exemplary case that the angle range of the freewheel section 26 extends over an angle range of 28°, a locking of the actuating arm 7, with the already-mentioned transmission ratio of 1:4, within an angle range of 7°, is not possible. The freewheel section 26 can include a curved-shaped, smooth contour which is free from recesses or elevations.

The first coupling elements 23a, 23b are pre-stressed by spring elements 27a, 27b in a direction of an uncoupled position from the second coupling element 24. The spring elements 27a, 27b are provided for pressing the coupling elements 23a, 23b into a compact rest position and to provide a defined release force. Only after overcoming the defined release force, the two first coupling element 23a, 23b can be releasably locked with the second coupling element 24.

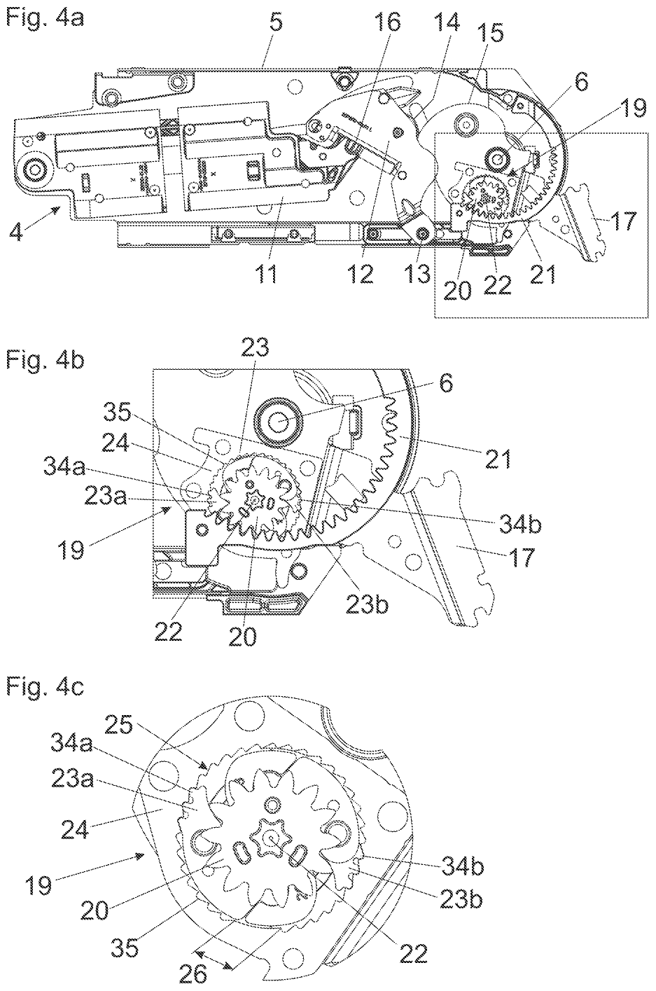

FIG. 4a shows a side view of the actuating drive 4, in which the actuating arm 7 (that is to say the coupling portion 17) is locked by the coupling device 19 in an open position of approximately 20°. FIG. 4b shows the framed region of FIG. 4a in an enlarged view, in which the actuating arm 7, upon exceeding the predetermined pivotal speed, is locked in a form-locking manner due to the locking of the two first coupling elements 23a, 23b with the second coupling element 24. From the position shown in FIG. 4b, the locking of the actuating arm 7 can be released such that the actuating arm 7 is manually pushed in a direction of the closed position. The two first coupling elements 23a, 23b can then be unlocked from the second coupling element 24 by a force of the spring elements 27a, 27b.

FIG. 4c shows an enlarged view of the coupling device 19, in which the tooth-arrangements 34a, 34b of the first coupling elements 23a, 23b engage into the counter-toothing 35 of the engagement section 25 of the second coupling element 24. The engagement section 25 can extend, for example, over an angle range of 330°, whereas the freewheel section 26 extends over 30°.

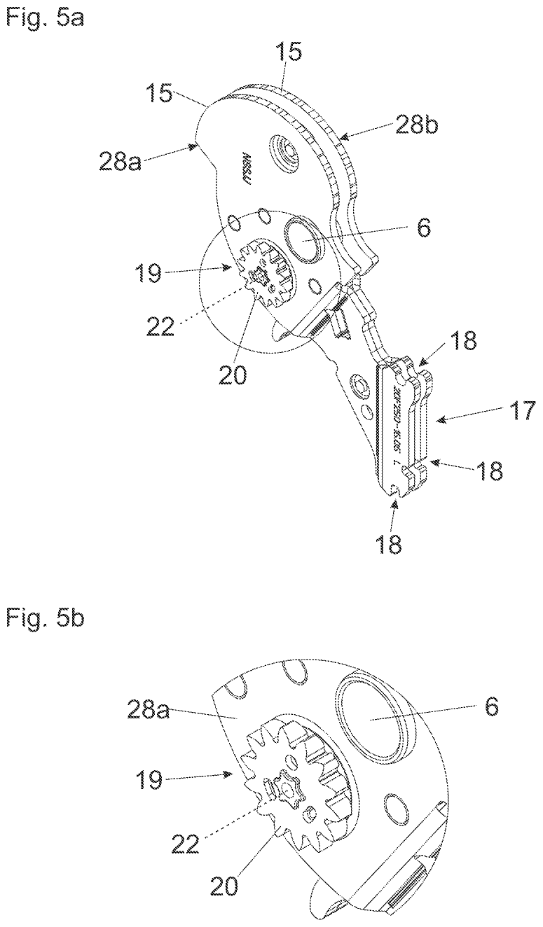

FIG. 5a shows a perspective view of the coupling portion 17 of the actuating drive 4, the coupling portion 17 being configured to be connected to the actuating arm 7. The coupling portion 17 includes a plurality of recesses 18 configured to receive possible fastening elements of the actuating arm 7, in particular pins and/or a spring-loaded tilting lever of the actuating arm 7, in a mounted condition of the actuating arm 7. The control contour 15 for the displaceable support of the pressure roller 14 is formed by a peripheral edge of two disc portions 28a, 28b which are mutually spaced from one another in a parallel relationship. The actuating arm 7, jointly with the coupling portion 17, is pivotally supported about the pivoting axis 6, and the gear 20 rotatable about the rotational axis 22 is configured to run along the curved-shaped toothed rack 21 of the actuating drive 4. The actuating arm 7, to which no furniture flap 3 has yet been fitted, is configured to be locked by the locking device 19 in a form-locking manner upon exceeding a predetermined pivotal speed. The pivoting axis 6 of the actuating arm 7 and the rotational axis 22 of the gear 20 are mutually spaced from one another in a substantially parallel relationship. FIG. 5b shows the encircled region of FIG. 5a in an enlarged view.

FIG. 6a shows the coupling device 19 in an exploded view, the coupling device 19 being received between the two disc portions 28a, 28b and being configured to pivot about the pivoting axis 6 upon a pivotal movement of the actuating arm 7. Gears 20 are arranged on both sides of the disc portions 28a, 28b, each of the gears 20 meshing with toothed rack 21 (FIG. 3a). The gears 20 are movement-coupled to one another by the shaft 30, and a rotatable rotor 29 is arranged on the shaft 30 for movably supporting the first coupling elements 23a, 23b. The first coupling elements 23a, 23b are arranged offset by 180° on the rotor 29. The rotor 29 includes two pivot bearings 31a, 31b for supporting the first coupling elements 23a, 23b. The second coupling element 24 includes an engagement section 25 for releasably locking the first coupling element 23a, and a freewheel section 26 separate from the engagement section 25. The freewheel section 26 is configured to prevent a locking between the first coupling element 23a and the second coupling element 24 when the actuating arm 7 is in the closed position. The other coupling element 23b is spaced from the coupling element 23a in an axial direction of the shaft 30, and the coupling element 23b is configured to be engaged with a further second coupling element 24a. The further coupling element 24a also includes a freewheel section 26a, the freewheel section 26a being arranged offset by 180° relative to the freewheel section 26 of the other coupling element 24.

FIG. 6b shows the encircled region of FIG. 6a in an enlarged view. Each of the first coupling elements 23a, 23b has a two-part configuration and are each connected to one another by rivets 32a, 32b. The rotor 29 includes two pivot bearings 31a, 31b configured to receive pivot portions 33a, 33b of the first coupling elements 23a, 23b.

1. An actuating drive for moving a furniture flap movably-supported relative to a furniture carcass, the actuating drive comprising:
at least one actuating arm pivotally supported about a pivoting axis for moving the furniture flap, the at least one actuating arm being movably supported between a closed position corresponding to a closed position of the furniture flap relative to the furniture carcass in a mounted condition of the furniture flap, and an open position,
a force storage member for applying a force to the at least one actuating arm,
a coupling device for braking or preventing a pivotal movement of the at least one actuating arm, the coupling device including at least one movably-supported first coupling element having a tooth arrangement, and the at least one first coupling element, when a predetermined pivotal speed of the actuating arm is exceeded, is configured to be engaged with a second coupling element, whereby the pivotal movement of the at least one actuating arm is braked or prevented, and the second coupling element includes at least one engagement section for engaging the two coupling elements with one another,
wherein the second coupling element includes a least one freewheel section separate from the engagement section, wherein the first coupling element, in the closed position of the actuating arm, is arranged within the freewheel section of the second coupling element, whereby the two coupling elements are decoupled from one another in the closed position of the actuating arm.

2. The actuating drive according to claim 1, wherein by the freewheel section of the second coupling element, the two coupling elements are decoupled from one another within a pivoting angle range of the actuating arm resulting between the closed position of the actuating arm and an opening position of the actuating arm of maximum 30°, preferably maximum 20°.

3. The actuating drive according to claim 1, wherein the at least one first coupling element is movably supported on a rotor, the rotor being rotationally supported about a rotational axis.

4. The actuating drive according to claim 3, wherein the rotor includes at least one pivot bearing for receiving a pivot portion of the first coupling element.

5. The actuating drive according to claim 3, wherein the rotational axis of the rotor and the pivoting axis of the actuating arm are mutually spaced from one another in a parallel relationship.

6. The actuating drive according to claim 1, wherein the first coupling element is pre-stressed by a force of a spring element in a direction of a decoupled position from the second coupling element.

7. The actuating drive according to claim 1, wherein the actuating drive includes a step-up gearing for transmitting a pivotal speed of the actuating arm, over at least a region of the pivoting path of the actuating arm, into a higher rotational speed of the first coupling element.

8. The actuating drive according to claim 7, wherein the step-up gearing includes at least one gear for driving the first coupling element, the gear being configured to be moved along a, preferably curved-shaped, toothed rack of the actuating drive upon a pivotal movement of the actuating arm about the pivoting axis.

9. The actuating drive according to claim 1, wherein the first coupling element includes a tooth arrangement and the engagement section of the second coupling element includes a, preferably curved-shaped, counter-toothing, wherein the tooth arrangement of the first coupling portion and the counter-toothing of the second coupling element are configured to be engaged with one another in a form-locking manner.

10. The actuating drive according to claim 1, wherein the second coupling element includes a substantially annular-shaped inner contour, wherein both of the engagement section and the freewheel section are arranged or formed on the annular-shaped inner contour of the second coupling element.

11. The actuating drive according to claim 1, wherein at least two first coupling elements are provided, each of the at least two first coupling elements being configured to be engaged with an engagement section of a second coupling element.

12. The actuating drive according to claim 11, wherein the two first coupling elements are arranged offset on the rotor by 180°.

13. An item of furniture comprising a furniture carcass, a furniture flap movably-supported relative to the furniture carcass, and the actuating drive according to claim 1 for moving the furniture flap.

14. The item of furniture according to claim 13, wherein the furniture flap covers the furniture carcass in a closed position, and achieves an elevated position relative to the furniture carcass in an open position.
